(19) United States
(12) Patent Application Publication
(10) Pub. No.: US 2014/0047742 A1
(43) Pub. Date: Feb. 20, 2014

(54) Edge Lit Magnetic Sign

(71) Applicant: Ben Schloss, Belmont, CA (US)

(72) Inventor: Ben Schloss, Belmont, CA (US)

(21) Appl. No.: 13/585,687

(22) Filed: Aug. 14, 2012

(51) Int. Cl. G09F 13/18

(52) U.S. Cl. CPC G09F 13/18
USPC 40/546

(57) ABSTRACT

An edge lit sign is magnetically attached to the underside of a mount, such as a tool box cover, having an uneven surface, wherein the edge lit sign is provided with spacers for holding the rear surface of the panel of the edge lit sign away from any surface of the tool box cover.

### BACKGROUND OF THE INVENTION

The present invention relates to the mounting of signs and signboards, and specifically to a system for mounting an edge-lit sign on the uneven surface of a tool box lid.

Edge lit signs are lighted signs that produce a pleasing effect where the design or figure (which may include characters or other symbols) of the sign is displayed brightly against a darkened, translucent background. Edge lit signs use a light source employed adjacent one or more edges of a light transmissive panel or substrate. Fluorescent lights were initially used for edge lit signs because they can be formed as elongate members that can run the length of an edge of a typical sign and provide substantially uniform illumination along their length, thus creating a sign with a pleasing appearance. However, fluorescent lights are generally bulky compared to the substrate or panel which is used as the sign or display. Strips of light emitting diodes and light emitting diode tape are now commonly used in edge lit signs, because the diodes are small enough and bright enough that they can be closely spaced together, sometimes in combination with a simple diffuser, to provide sufficiently uniform illumination to an edge lit sign. The strips can be made very thin relative to the edge of the substrate or panel, thus the sign or display need not be bulky.

It is important with edge-lit signs that the sign or substrate itself be protected from abrasion or smudging that would collect light and thereby detract from the intended display. Thus it is important with edge lit signs to space the panel from surrounding objects. It is especially important in the present case where the panel is designed to be attached to object that moves, the underside of a tool box lid, and is in close proximity to that object, such that it is important that the fastening will maintain the separation between the panel and the object.

Edge lit signs have been described in the patent literature, and such patents include U.S. Pat. No. 6,094,849, granted to James A Phillips et al, the entire disclosure of which is hereby incorporated herein by reference; U.S. Pat. No. 6,471,388, granted to Brent Marsh, the entire disclosure of which is hereby incorporated by reference; and U.S. Pat. No. 7,681,347, granted to Brian Hart Welker et al, the entire disclosure of which is hereby incorporated by reference.

The present invention provides a mechanism for attaching an edge lit sign to a magnetic surface, having multiple levels, while spacing the substrate or panel of the sign sufficiently away from the surface so that the surface does not interfere with the display of the sign.

### SUMMARY OF THE INVENTION

The present invention provides an edge lit display, wherein the edge lit display has a light transmissive panel having a front face and an opposed rear face with at least one of the front and rear faces having a figure formed by at least one groove recessed into the face, the panel further having one or more light entering surfaces, one or more of the light entering surfaces having a light source in close proximity thereto, the edge lit display further having one or more magnets attached thereto for releasably connecting the display to a ferrous metalic mount with an uneven surface such that the panel is spaced away from the surfaces of the mount.

A principal advantage of the present invention is that the spacing of the display from the mount is accomplished with adjustable spacers without creating a bulky appearance.

### BRIEF DESCRIPTION OF THE DRAWINGS

FIG. 1A is a perspective view of the edge lit sign of the present invention without any illumination from the light source.

FIG. 1B is a perspective view of the edge lit sign of the present invention, depicted with the light source illuminated.

FIG. 2A a perspective view of the edge lit sign installed on the under surface of a tool box lid, having a surface contour without any illumination from the light source.

FIG. 2B a perspective view of the edge lit sign installed on the under surface of a tool box lid having a surface contour with the light source illuminated.

FIG. 3 is a sectional view of the sign of the present invention taken along line 3-3 of FIG. 1.

FIG. 3A is an exploded view of the sign of the preset invention taken along line 3A of FIG. 3.

FIG. 4 is a side view of the sign of the present invention.

FIG. 5 is a sectional view of the sign of the present invention roughly taken along line 5-5 of FIGS. 1 and 4.

FIG. 6 is a sectional view of the sign mounted on a magnetic surface, similar to FIG. 5.

FIG. 7 is a sectional view of the sign mounted to a magnetic surface that has a contour, similar to FIG. 6.

FIG. 7A is an enlarged view taken along line 7A of FIG. 7.

### DETAILED DESCRIPTION

For clarity and convenience, the display or sign 1 of the current invention is described in a single, most common, orientation (except as noted otherwise) in which a top faces up and a bottom faces down. The sign 1 can, nevertheless, be installed in essentially any orientation, so that a top can face down or to the side and a bottom can face up or to the side.

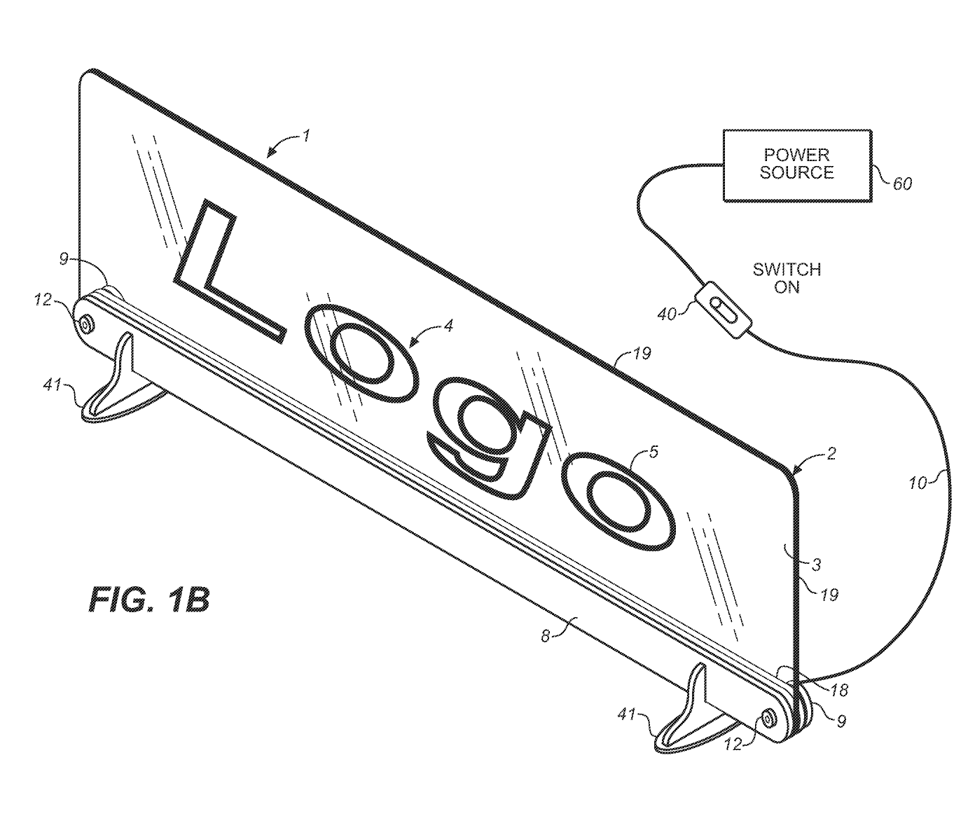

As best shown in FIGS. 2A, 2B, 5, 6, 7 and 7A, the present invention is a connection between an edge lit display 1 and a mount 50.

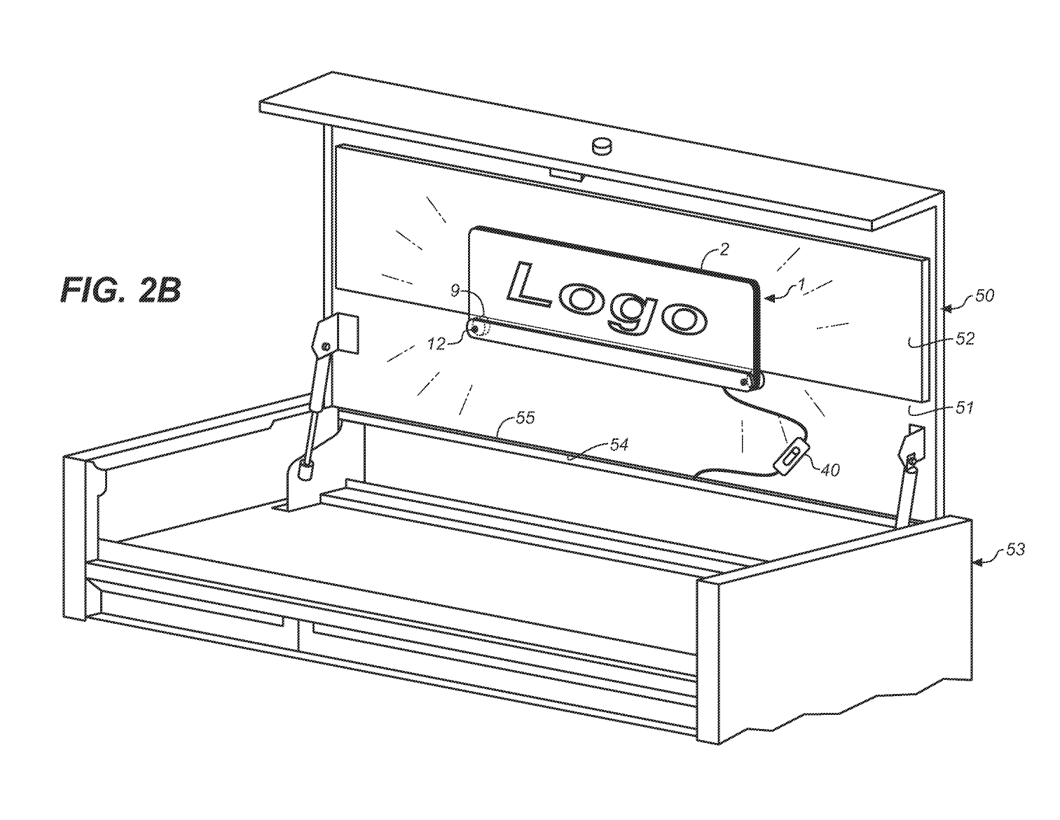

The edge lit display 1 has a light transmissive panel 2 having a front face 3 and an opposed rear face 15 with at least one of the faces 3 and 15 having a FIG. 4 formed by at least one groove 5 recessed into that face 3 or 15. The panel 2 further has one or more light entering surfaces 6 and one or more of the light entering surfaces 6 has a light source 7 in close proximity thereto. The light source 7 is connected to an electrical power source (not shown) to energize the light source 7. The edge lit display 1 also has one or more covers 8 and 18 which shield the light source 7 so that a substantial portion of the light emitted by the edge lit display 1 is transmitted through the panel 2. The edge lit display 1 further has one or more magnets 9 attached thereto for releasably connecting the display 1 to the mount 50.

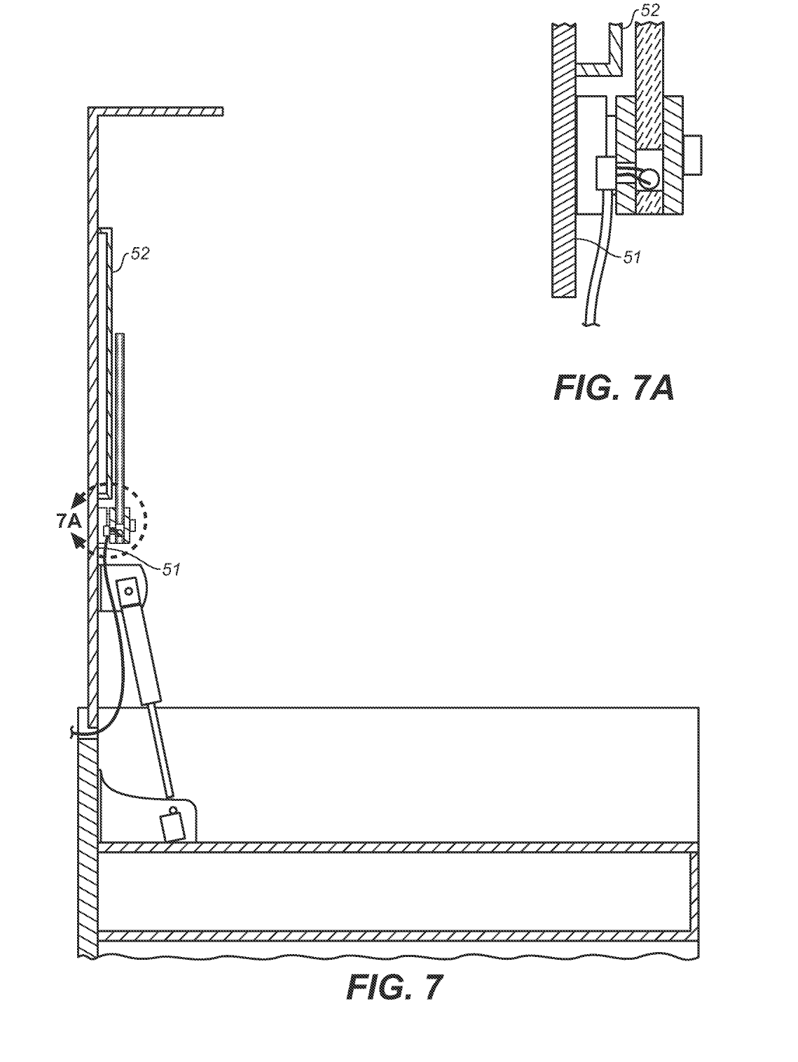

The mount 50 is a metallic member, having at least a first distal surface 51 and a second proximal surface 52. The first and second surfaces 51 and 52 of the mount 50 face the rear face 15 of the panel 2 with the first distal surface 51 of the mount being farther away from the rear face 15 of the panel 2 than the second proximal surface 52 of the mount 50. As show in in FIGS. 2A, 2b, 7 and 7A the preferred mount 50 is the movable lid 50 of a storage box 53, and the first distal surface 51 and the second proximal surface 52 are parts of the underside of the storage box lid 50.

As best shown in FIGS. 7 and 7A the one or more magnets 9 attached to the display 1 are releasably connected to the first distal surface 51 of the mount and the rear face 3 of the panel 2 is spaced away from both the first distal surface 51 of the mount 50 and the second proximal surface 52 of the mount 50. As is also shown in FIG. 7, the wire 10 connecting the display 1 to its power supply 60 is run between the edge 54 of the lid 50 and the back face 55 of the storage or tool box 53. As is also shown in FIG. 7, the display 1 is located on the underside of the lid 50 so that most of the panel 2 is disposed adjacent the second proximal surface 52 of the mount or lid 50, and the panel 2 is held in close proximity to the second proximal surface 52 of the mount or lid 50 and the panel 2 itself is very narrow as well as the front cover 8 of the display 2 such that room underneath the display 1 in the box 53 for storage of materials is maximized.

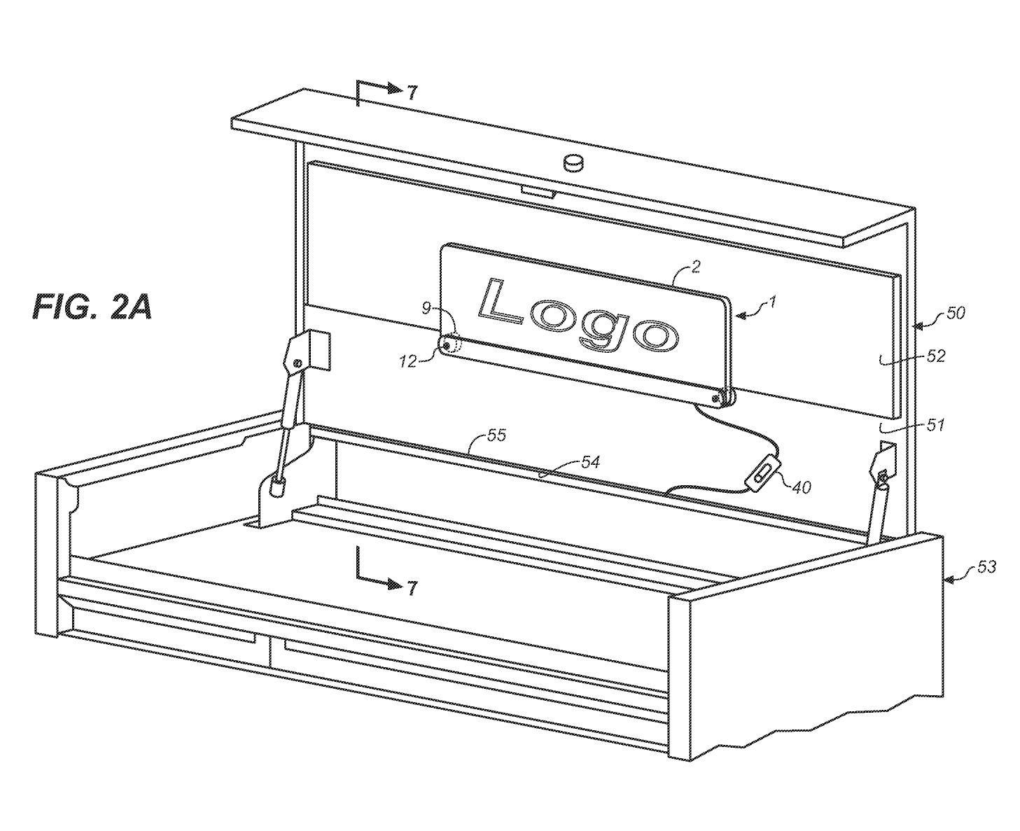

As best shown in FIGS. 3 and 4, in the preferred embodiment the light source 7 is an array of light emitting diodes 20 which is concealed by a pair of thin, elongated front and rear covers 8 and 18 on either side of the panel 2. As best shown in FIG. 7A, an additional cover 21 is provided where the wiring 10 to the power supply passes through the rear cover 18.

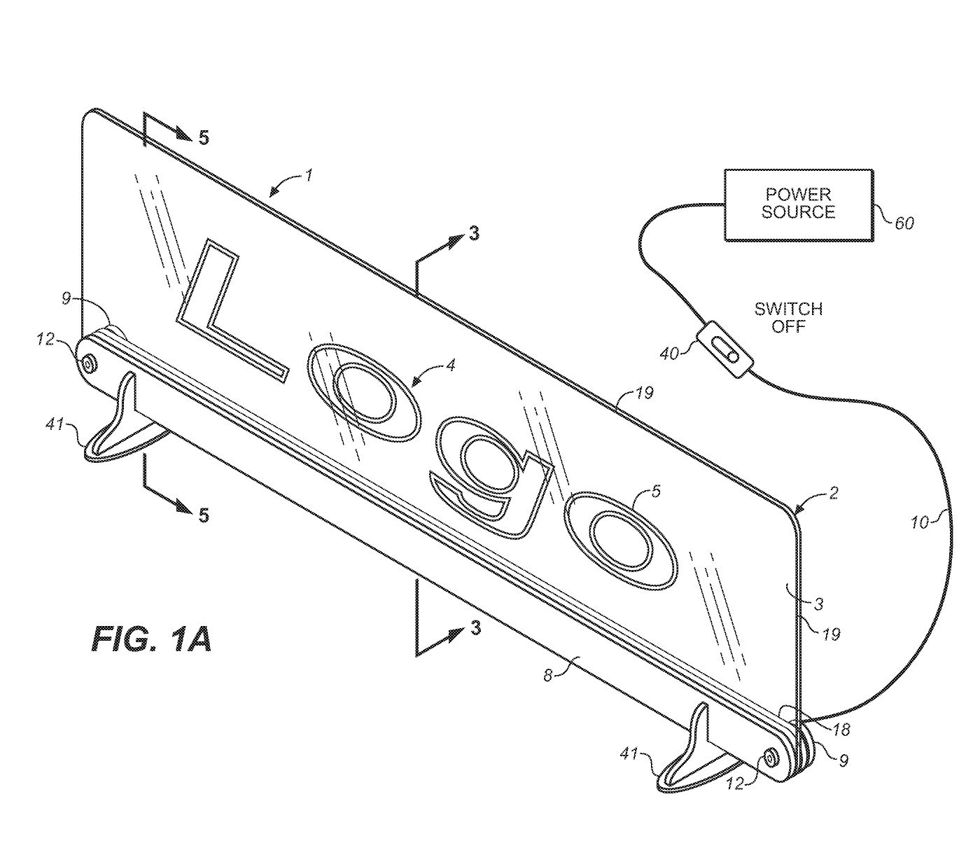

As best shown in FIGS. 1A, 1B, 5 and 6, in the preferred embodiment the display 1 is provided with a pair of magnets 9 that are disposed on the rear cover 18 of the display 1. The magnets 9 are secured to the display by bolts 12 that run through the front cover 8, the panel 2, and the rear cover 18 respectively. The magnets 9 are preferably cylindrical magnets 9 with a flat contact surface 13. The magnets 9 could also be adhesively fixed to the display 1.

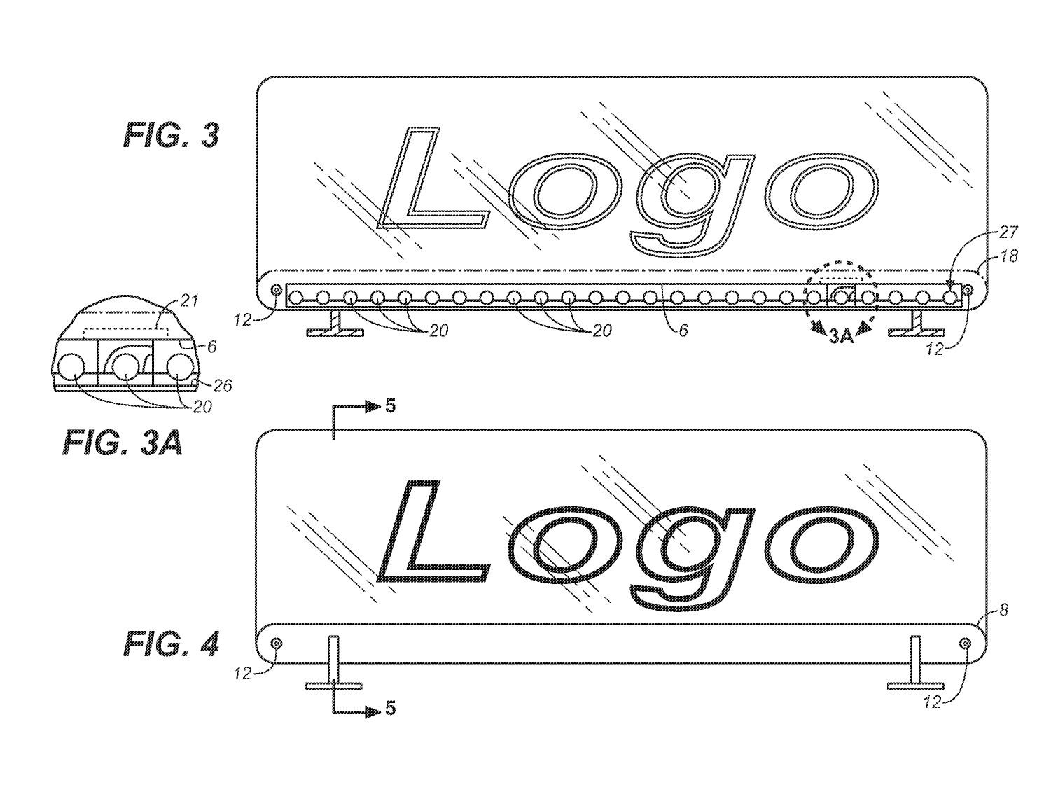

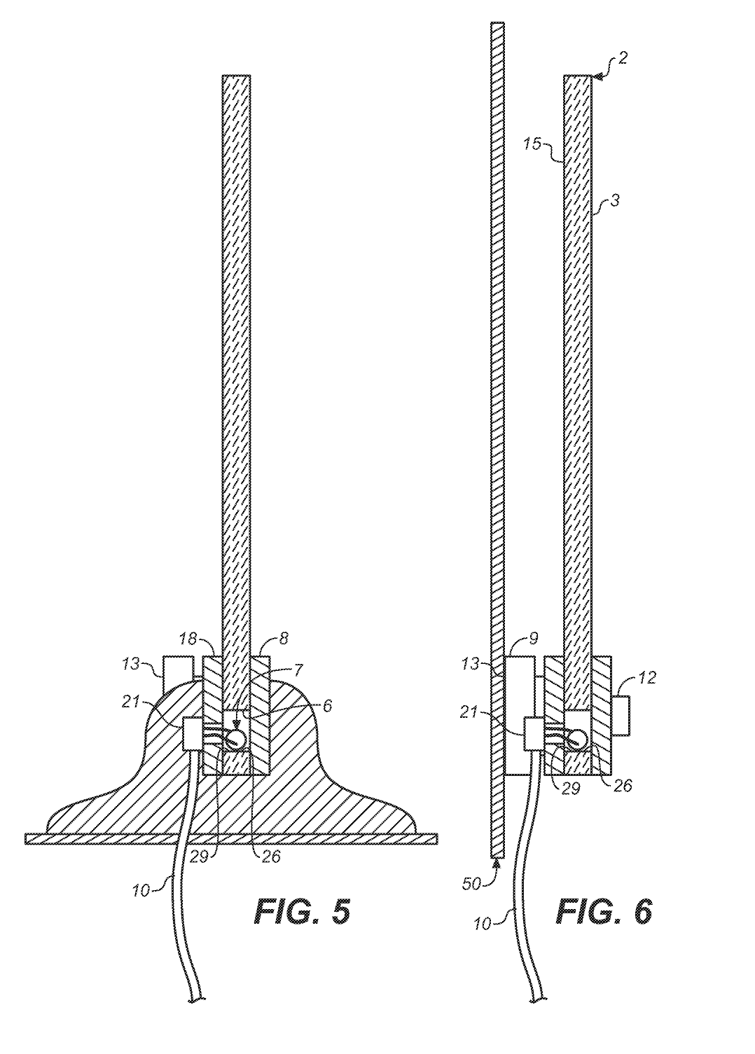

As is best shown in FIGS. 5 and 6 a spacer 14, in the form of a washer is provided between the rear cover 18 and the magnet 9 so at to provide sufficient space between the attachment or contact surface 13 of the magnet 9 and the rear face 15 of the panel 2 such that when the display 1 is attached to a mount 50 of particular form and arrangement, the rear face 15 of the panel 2 will clear the second proximal surface 52 of the mount 50. The spacer 14 may be removed, its dimensions changed, additional spacers 14 added, or it may be disposed between the head 16 of the bolt 12, and the bolt 12 may be elongated or shortened, depending on the clearance needed between the rear face 18 of the panel 2 and the second proximal surface 52 of the mount 50. Preferably, the spacers 14 are no wider than the magnets 9.

As shown in FIGS. 1A and 1B, the FIG. 4 is depicted here as a representative text, but the figure is not limited to textural material, and is especially suited to represent artwork, such as advertising logos or trademarks. The FIG. 4 can be molded into the panel 2 during formation of the panel 2, or it can be etched or machined into the surface 3 or 15 of the panel 2. The FIG. 4 is preferably grooved on just one surface 3 or 15 of the panel 2 for ease of manufacture and for providing a pleasing appearance. Preferably, the panel 2 has a front face 3—the first surface 3 of the panel 2, through which an edge illuminated image in the form of the FIG. 4 is normally viewed. In the preferred embodiment the front face 3 or first surface 3 of the panel 2 parallels the opposed rear face 15 or second surface 15 of the panel 2, and the FIG. 4 is formed by a series of grooves 5 in the rear face 15 of the panel 2.

In the preferred embodiment, the groove 5 is formed with sides that have an acute angle relative to the smooth surface 3 or 15 of the panel 2. A light entering surface 6 is formed at one side or edge of the panel 2. The light entering surface 6 can be formed to diffuse the light entering the panel 2. The light entering surface 6 extends transversely relative to the faces 3 and 15 of the panel. The grooves 5, recessed into one of the smooth front or rear faces 3 or 15 of the panel 2, and the light entering surface 6 are parts of a one-piece substrate forming the panel 2.

The panel 2 is preferably formed with opposed smooth front and rear faces 3 and 15, with peripheral edges 19 extending between the opposed faces 3 and 18. The panel 2 is preferably made from a molded plastic, such as acrylic.

In the preferred embodiment, the light source 7 is an array of discrete light emitting diodes 20 arranged along the light entering surface 6 of the panel 2, so that light shines through the light entering surface 6 to be dispersed and to evenly shine through the panel 2 to strike the sides forming the at least one groove 5 to form an illuminated edge lit image or FIG. 4 conforming to the sides of the at least one groove 5.

In the preferred embodiment, where the light source 7 is formed from light emitting diodes 20, the individual light emitting diodes 20 forming the array of discrete light sources are mounted on a conductive film or circuit board (not shown), which is in turn connected to a conventional source of electrical energy 60 and a controller 40. In the preferred embodiment as shown in FIGS. 1A and 1B, the controller 40 is a simple switch.

In the embodiment depicted herein, the light emitting diodes 20 and the circuit forming the array 27 are mounted on a shelf 26 which extends beyond the light entering surface 6. This shelf comprises an integral extension of the one-piece, molded panel 2. The flexible circuit can be attached to the shelf 26 by conventional means, such as adhesives or mechanical fasteners. With the array 27 mounted in this manner, the individual light emitting diodes 20 can be positioned in close proximity to the light entering surface 6 so that light will shine through the lenses of the light emitting diodes into the light transmissive panel 2. In the preferred embodiment an opaque tape 29 is disposed on the shelf 26 to block light that would leave from the bottom of the sign, providing a more pleasing appearance.

The individual light emitting diodes 20 in the array 27 emit light through the panel 2 between the faces 3 and 15 of the panel 2.

As shown in FIG. 1, the edge lit display 1 can be used with stands 41 to support it.

1. A connection between an edge lit display and a mount comprising:
a. the edge lit display, wherein the edge lit display has a light transmissive panel having a front face and an opposed rear face with at least one of said front and rear faces having a figure formed by at least one groove recessed into the face, the panel further having one or more light entering surfaces, one or more of the light entering surfaces having a light source in close proximity thereto; the light source being connected to an electrical power source to energize the light source; the edge lit display further having one or more magnets attached thereto for releasably connecting the display to the mount;
b. the mount, wherein the mount is a ferrous metallic member, having a first distal surface, and a second proximal surface, the first and second surfaces of the mount facing the rear face of the panel with the first distal surface of the mount being farther away from the rear face of the panel than the second proximal surface of the mount; wherein
c. the one or more magnets are attached to the display and are releasably connected to the first distal surface of the mount, and the rear face of the panel is spaced away from both the first proximal surface of the mount and the second distal surface of the mount.

2. The connection of claim 1, wherein:
one or more spacers are provided between the edge lit display and the magnets to provide sufficient spacing between the second proximal surface of the mount and the rear face of the panel of the edge lit display.

3. The connection of claim 2, wherein:
the magnets are mounted to the edge lit display by bolts and the spacers are provided on the bolts between the magnets and the panel of the edge lit display.

4. The connection of claim 3, wherein:
the edge lit display is provided with front and rear coves to shield the light source and the spacer is provided between the magnet and the rear cover.

5. The connection of claim 4, wherein:
the light source is mounted on a shelf which extends beyond the light entering surface, and this shelf is an integral extension of the panel 2.

6. The connection of claim 5, wherein:
an opaque tape is disposed on the shelf to block light.

7. The connection of claim 1, wherein:
the spacers are no wider than the magnets.
